(19) United States
(12) Patent Application Publication
(10) Pub. No.: US 2017/0187190 A1
(43) Pub. Date: Jun. 29, 2017

(54) DISTRIBUTED POWER SUPPLY SYSTEM, POWER CONVERTER DEVICE, AND METHOD OF CONTROLLING POWER FACTOR

(71) Applicant: TABUCHI ELECTRIC CO., LTD., Osaka (JP)

(72) Inventors: Hiroshi ASANO, Osaka (JP); Hirofumi KONISHI, Osaka (JP)

(73) Assignee: TABUCHI ELECTRIC CO., LTD., Osaka (JP)

(21) Appl. No.: 15/263,104

(22) Filed: Sep. 12, 2016

(30) Foreign Application Priority Data
Dec. 28, 2015 (JP) 2015-257093
Aug. 10, 2016 (JP) 2016-157172

(51) Int. Cl. H02J 3/38; H02J 7/35; H02J 3/18; H02M 7/44; H02M 3/04

(52) U.S. Cl. CPC H02J 3/383; H02M 7/44; H02M 3/04; H02J 3/18; H02J 7/35

(57) ABSTRACT

A distributed power supply system includes a controller configured to control a power factor of a power converter device (inverter) such that the power factor has a predetermined constant value if reverse power flow from the power converter device (inverter) to a utility power grid is observed. If the controller determines, based on reverse power flow information acquired by a reverse power flow information acquirer, that reverse power flow from the power converter device (inverter) to the utility power grid is not observed, the controller controls the power factor of the power converter device (inverter) such that the power factor has a value closer to unity than the predetermined constant value is.

### CROSS-REFERENCE TO RELATED APPLICATION

This application claims priority to Japanese Patent Applications No. 2015-257093 filed on Dec. 28, 2015, and No. 2016-157172 filed on Aug. 10, 2016, the entire disclosures of which are hereby incorporated by reference.

### BACKGROUND

The present disclosure relates to a distributed power supply system including a distributed power supply such as a photovoltaic (PV) power generator, a power converter device applicable to such a distributed power supply system, and a method of controlling a power factor of such a power converter device.

Nowadays, distributed power supplies such as PV power generators have been widely used, and those non-utility power facilities and their associated parts are more and more often connected to low-voltage distribution lines. The Japan Electric Association, Grid-interconnection Code, JEAC9701-2012 (Appendix 1, 2015) (page 8) states that such an upsurge in grid interconnection could possibly cause a voltage rise in, e.g., high-voltage distribution lines. Furthermore, this document also discloses that, in order to deal with the voltage rise, it is effective to provide a power conditioner which is connected to a distributed power supply with a function of performing a leading power factor operation always at a constant power factor, i.e., a function of performing a so-called “constant power factor control” (for example, at a power factor of 0.9). As can be seen, operating the power conditioner at a constant power factor may reduce a rise in grid voltage to maintain a proper grid voltage level.

### SUMMARY

As disclosed in, e.g., Japanese Patent No. 5452422, a distributed power supply system including a plurality of distributed power supplies (including a power generator facility and a power storage facility) supplies power to a load such as a household or industrial appliance using the distributed power supplies.

The distributed power supply system is configured such that if the power supplied from the distributed power supplies is larger in this situation than the power consumed by the load, reverse power flow from the distributed power supplies to a utility power grid may be allowed to sell the power to an electric power company. During this reverse power flow, the above-described constant power factor control may be required.

On the other hand, if the power supplied from the distributed power supplies is smaller than power consumed by the load, the power supplied from the distributed power supplies is consumed by the load within the distributed power supply system, and reverse power flow from the distributed power supplies to the utility power grid is not observed. If the power factor is controlled to be constant in such a situation, power efficiency may decrease because the apparent power needs to be increased.

In view of the foregoing background, it is therefore an object of the present disclosure to provide a distributed power supply system that optimizes power efficiency while taking an appropriate countermeasure against a rise in grid voltage.

A distributed power supply system according to the present disclosure includes a controller configured to control a power factor of a power converter device such that the power factor has a predetermined constant value if reverse power flow from the power converter device to a utility power grid is observed. If the controller determines, based on reverse power flow information acquired by a reverse power flow information acquirer, that reverse power flow from the power converter device to the utility power grid is not observed, the controller controls the power factor of the power converter device such that the power factor has a value closer to unity than the predetermined constant value is.

If the power factor is closer to unity, the power efficiency is better. Thus, when determining that reverse power flow is not observed, the controller controls the power factor of the power converter device such that the power factor is closer to unity than a predetermined constant value is. This control may enhance the power efficiency of the distributed power supply system.

That is to say, a first aspect of the present disclosure provides a distributed power supply system including: a plurality of distributed power supplies; a power converter device having a DC/AC conversion function, and configured to DC/AC convert output power of the plurality of the distributed power supplies and supply the converted power to a load and to connect the plurality of the distributed power supplies to a utility power grid; a reverse power flow information acquirer configured to acquire reverse power flow information indicating whether or not reverse power flow from the power converter device to the utility power grid is observed; and a controller configured to control a power factor of the power converter device such that the power factor has a predetermined constant value if reverse power flow from the power converter device to the utility power grid is observed. If the controller determines, based on the reverse power flow information, that reverse power flow from the power converter device to the utility power grid is not observed, the controller controls the power factor of the power converter device such that the power factor has a value closer to unity than the predetermined constant value is.

According to this configuration, in a distributed power supply system, a controller controls a power factor of a power converter device such that the power factor has a predetermined constant value if reverse power flow is observed. If the controller determines that reverse power flow is not observed, the controller controls the power factor such that the power factor has a value closer to unity than the constant value is. This may improve the power efficiency of the distributed power supply system, as described above.

If reverse power flow from an authorized non-utility power supply is observed and if a power storage device is included in a distributed power supply, power discharge from the power storage device is generally stopped. In that case, the controller controls the power factor of the power converter device such that the power factor has a predetermined constant power factor. Thereafter, when the power consumed by the load exceeds the power supplied from the authorized non-utility power supply, i.e., when reverse power flow is not observed, the power storage device needs to make up for the power deficit. In that case, if the power factor of the power converter device is continuously controlled to have a predetermined constant value, the power sufficiency declines. As a result, the power storage device will be exhausted sooner than in a case where the power factor of the power converter device is controlled to be closer to unity than the predetermined constant value is. This is a problem.

In contrast, according to the present aspect, if the controller determines, based on the reverse power flow information, that reverse power flow is not observed, it controls the power factor of the power converter device such that the power factor has a value closer to unity than the predetermined constant value is. As a result, even if the power storage device needs to make up for the power deficit, higher power efficiency is achieved compared with a case where the power factor of the power converter device is controlled to have the predetermined constant value. Consequently, the power storage device may be less exhausted. This enables not only utilizing the power stored in the power storage device more efficiently and effectively but also reducing the charge/discharge amount and the number of times of power charge or discharge. As a result, the power storage device may have a longer life.

Also, if, e.g., the distributed power supplies include an unauthorized non-utility power supply from which reverse power flow is not allowed and reverse power flow from the authorized non-utility power supply is observed, then power discharge from the unauthorized non-utility power supply is generally stopped. In that case, the controller controls the power factor of the power converter device such that the power factor has a predetermined constant value. Thereafter, when the power consumed by the load exceeds the power supplied from the authorized non-utility power supply, i.e., when the reverse power flow is not observed, the unauthorized non-utility power supply needs to make up for the power deficit. In that case, if the power factor of the power converter device is continuously controlled to have a predetermined constant value, the power efficiency declines. As a result, the power efficiency of the unauthorized non-utility power supply deteriorates, compared with a case where the power factor of the power converter device is controlled to be closer to unity than the predetermined constant value is. This is a problem.

In contrast, according to the present aspect, if the controller determines, based on the reverse power flow information, that reverse power flow is not observed, it controls the power factor of the power converter device such that the power factor has a value closer to unity than the predetermined constant value is. As a result, even if the unauthorized non-utility power supply needs to make up for the power deficit, the power efficiency of the unauthorized non-utility power supply may be increased compared with a case where the power factor of the power converter device is controlled to have the predetermined constant value. Consequently, the power supplied by the unauthorized non-utility power supply may be utilized more efficiently and effectively.

The reverse power flow information acquirer may be a current detector configured to detect a power transmission current flowing through a power transmission line connecting the power converter device to the utility power grid, and to output the detected current as the reverse power flow information. If the controller determines, based on the power transmission current, that reverse power flow from the power converter device to the utility power grid is not observed, the controller may control the power factor of the power converter device such that the power factor has a value closer to unity than the predetermined constant value is.

According to this configuration, a current detector outputs, as reverse power flow information, the current value of a power transmission current flowing through a power transmission line connecting the power converter device to the utility power grid. Thus, the controller may acquire more accurate information indicating whether or not reverse power flow is observed. This may control the power factor of the power converter device with higher precision.

The plurality of the distributed power supplies may include a power storage device. The reverse power flow information acquirer may be a discharge information acquirer configured to output, as the reverse power flow information, discharge information indicating whether or not power is discharged from the power storage device. If the controller determines, based on the discharge information, that power is discharged from the power storage device, the controller may control the power factor of the power converter device such that the power factor has a value closer to unity than the predetermined constant value is.

If the power storage device serves as an unauthorized non-utility power supply from which reverse power flow is not allowed and if power is discharged from the power storage device, the controller generally controls the power storage device such that reverse power flow is not observed, for example. Thus, if power is discharged from the power storage device, controlling the power factor of the power converter device to be closer to unity than the predetermined constant value is may improve the power efficiency of the distributed power supply system as significantly as in the first aspect. In addition, the power stored in the power storage device may be utilized more efficiently and effectively, and the life of the power storage device may be extended.

If the controller determines, based on the reverse power flow information, that reverse power flow from the power converter device to the utility power grid is not observed, the controller may control not only the power factor of the power converter device but also an output power level of the power converter device such that as the power consumed by the load increases or decreases, the output power level of the power converter device increases or decreases accordingly.

Controlling the power factor of the power converter device to be closer to unity than the predetermined constant value is may improve the power efficiency of the distributed power supply system, as described above. On the other hand, after the above power factor control, the power supplied from the distributed power supplies may exceed the power consumed by the load. That is to say, reverse power flow from the power converter device to the utility power grid may be observed. If a determination is made that reverse power flow from the power converter device to the utility power grid is not observed as in this aspect, not only the power factor of the power converter device but also the output power thereof may be controlled. This may maintain a state in which reverse power flow is not observed regardless of the relation in level between the power supplied from the distributed power supplies and the power consumed by the load. As a result, even if, e.g., power is discharged from the power storage device serving as an unauthorized non-utility power supply from which reverse power flow is not allowed, this power discharge from the power storage device may be continued.

A second aspect of the present disclosure provides a method of controlling a power factor of a power converter device configured to DC/AC convert output power of a plurality of distributed power supplies and supply the converted power to a load and to connect the plurality of the distributed power supplies to a utility power grid, the power converter device being controlled such that the power factor has a predetermined constant value if reverse power flow from the power converter device to the utility power grid is observed. The method includes: acquiring reverse power flow information indicating whether or not reverse power flow from the power converter device to the utility power grid is observed; and controlling the power factor of the power converter device such that the power factor of the power converter device has a value closer to unity than the predetermined constant value is if a determination is made, based on the reverse power flow information, that reverse power flow from the power converter device to the utility power grid is not observed.

According to this configuration, if a determination is made based on the reverse power flow information that reverse power flow from the power converter device to the utility power grid is not observed, the power factor of the power converter device is controlled to be closer to unity than the predetermined constant value is. Thus, the power efficiency of the distributed power supply may be improved as significantly as in the first aspect. In addition, the power stored in the power storage device may be utilized more efficiently and effectively, and the life of the power storage device may be extended.

A third aspect of the present disclosure provides a power converter device including: an inverter configured to DC/AC convert output power of a plurality of distributed power supplies and supply the converted power to a load and to connect the plurality of the distributed power supplies to a utility power grid; a reverse power flow information acquirer configured to acquire reverse power flow information indicating whether or not reverse power flow from the inverter to the utility power grid is observed; and a controller configured to control a power factor of the inverter such that the power factor has a predetermined constant value if reverse power flow from the inverter to the utility power grid is observed. If the controller determines, based on the reverse power flow information, that reverse power flow is not observed, the controller controls the power factor of the inverter such that the power factor has a value closer to unity than the predetermined constant value is.

According to this configuration, as in the first aspect, if the controller determines, based on the reverse power flow information, that reverse power flow is not observed, the controller controls the power factor of the inverter such that the power factor has a value closer to unity than the predetermined constant value is. This may improve the power efficiency of the distributed power supplies. Also, if, e.g., the distributed power supplies include a power storage device, the power stored in the power storage device may be utilized more efficiently and effectively, and the life of the power storage device may be extended.

In accordance with the present disclosure, depending on whether or not reverse power flow from a power converter device to a utility power grid is observed, the modes of control are switched between a constant power factor control and a changeable power factor control that allows the power factor to change according to the load. This may optimize the power efficiency while taking an appropriate countermeasure against a rise in grid voltage.

### BRIEF DESCRIPTION OF THE DRAWINGS

FIG. 1 illustrates an exemplary overall configuration of a distributed power supply system.

FIG. 2 is a flowchart showing an exemplary flow of control to be performed by a system controller.

FIG. 3 illustrates how to perform a constant power factor control.

FIG. 4 is a flowchart showing another exemplary flow of control to be performed by the system controller.

FIG. 5 illustrates another exemplary overall configuration of the distributed power supply system.

### DETAILED DESCRIPTION

Embodiments of the present disclosure will now be described in detail with reference to the accompanying drawings. The following embodiments are merely preferred examples in nature, and are not intended to limit the scope, application, or uses of the present disclosure.

### Configuration of Distributed Power Supply System

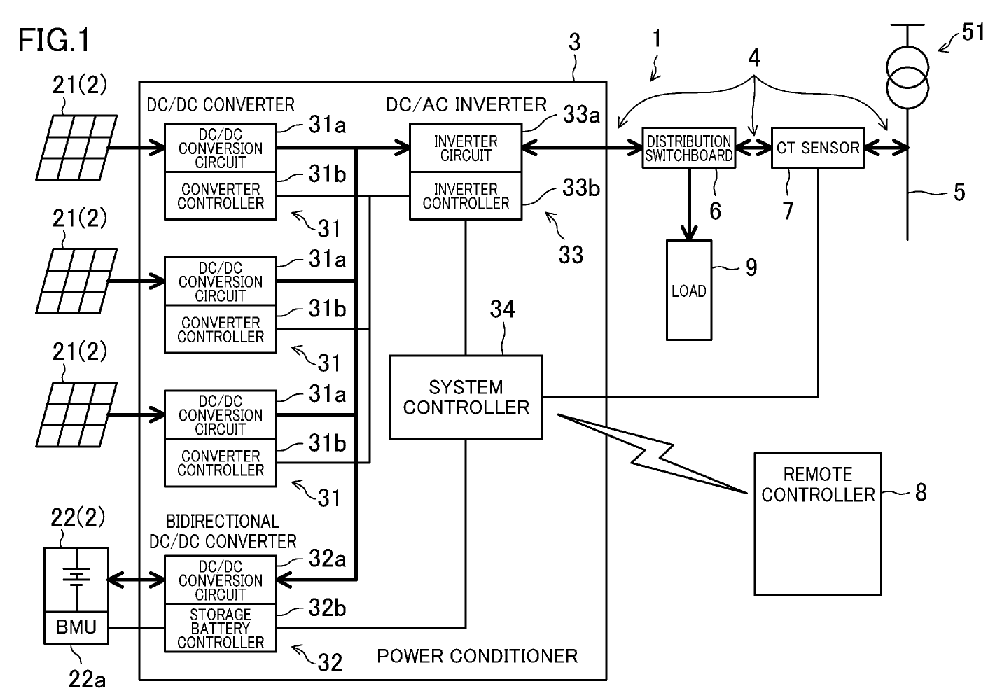

FIG. 1 illustrates an exemplary overall configuration of a distributed power supply system according to an exemplary embodiment.

This distributed power supply system 1 includes a plurality of distributed power supplies 2, 2, . . . , and a power conditioner 3 converting direct current (DC) power supplied from the distributed power supplies 2, 2, . . . , to alternating current (AC) power to supply the power to a load 9 (hereinafter simply referred to as a “load”), such as a household or industrial appliance, connected to a power transmission line.

FIG. 1 illustrates an example in which the distributed power supplies 2, 2, . . . , include three photovoltaic power generators 21, 21, . . . , and a storage battery 22 serving as a power storage device. In the following description, the photovoltaic power generators 21, 21, . . . , are supposed to serve as authorized non-utility power supplies from which reverse power flow is allowed into a utility power grid 5 in compliance with the grid-interconnection code. The storage battery 22 may be, e.g., a chargeable and dischargeable secondary battery such as a lithium-ion battery or lead storage battery, and is supposed to serve as an unauthorized non-utility power supply from which reverse power flow is not allowed into the utility grid 5.

The power conditioner 3 is further configured to connect the plurality of distributed power supplies 2, 2, . . . , to the utility power grid 5 through a power transmission line 4. A distribution switchboard 6 is provided between the power conditioner 3, the utility power grid 5, and the load 9. The distribution switchboard 6 is configured to selectively connect or disconnect the power conditioner 3, the utility power grid 5, and the load 9 to/from each other. A current transformer (CT) sensor 7 is further connected to the power transmission line 4 between the distribution switchboard 6 and the utility power grid 5. The CT sensor 7 measures the amount of a current flowing through the power transmission line 4.

With such a configuration, if the power supplied from the distributed power supplies 2, 2, . . . , (comprising the plural photovoltaic power generators 21, 21, . . . , and/or the storage battery 22) falls below the power consumed by the load 9, the distributed power supply system 1 supplies all the power supplied to the load 9. On the other hand, in, e.g., fine weather, if the power supplied from the photovoltaic power generators 21, 21, . . . , of the distributed power supplies 2, 2, . . . , i.e., the authorized non-utility power supplies, exceeds the power consumed by the load, reverse power flow from the photovoltaic power generators 21, 21, . . . , is observed and sold to the utility power grid.

### Configuration of Power Conditioner

The power conditioner 3 includes a plurality of DC/DC converters 31, . . . , 32, a bidirectional DC/AC inverter 33 (hereinafter simply referred to as an “inverter”), and a system controller 34. The DC/DC converters 31, . . . , 32 are provided such that each of the DC/DC converters 31, . . . , 32 is associated with one of the plural photovoltaic power generators or the storage battery.

Each of the DC/DC converters 31 connected to an associated one of the photovoltaic power generators 21 includes a DC/DC conversion circuit 31a receiving power from the photovoltaic power generator 21 and boosting or lowering the voltage of the supplied power in accordance with the voltage of the generated power, and a converter controller 31b controlling the conversion operation of the DC/DC conversion circuit 31a. Each of the converter controllers 31b controls the power extracted from the photovoltaic power generator, and may be configured, for example, to perform a tracking control of the maximum operating point. This tracking control of the maximum operating point may allow for extraction of the maximum power from each of photovoltaic power generators 21. The DC/DC conversion circuit 31a and the converter controller 31b in each of the DC/DC converters 31 may have the same or similar configuration as/to conventional ones such as those disclosed in, e.g., Japanese Patent No. 5452422, and detailed description thereof will be omitted herein.

The DC/DC converter 32 connected to the storage battery 22 is a bidirectional DC/DC converter, and includes a DC/DC conversion circuit 32a provided between the storage battery 22 and the inverter 33 and a storage battery controller 32b configured to control the charge/discharge amount of the storage battery 22 that is connected to itself. The DC/DC conversion circuit 32a may have the same or similar configuration as/to a conventional one, and detailed description thereof will be omitted herein.

The storage battery controller 32b controls charging and discharging of the storage battery 22 in accordance with an instruction from a system controller 34 which will be described later. The storage battery controller 32b is also configured to transmit and receive data to/from a battery management unit (BMU) 22a included in the storage battery 22 that is connected to itself, and acquires information about the storage battery 22 from the BMU 22a such as the power level of the storage battery 22 and information indicating whether or not power is discharged.

The storage battery controller 32b controls charge/discharging of the storage battery 22, and thus, may acquire, based on its own charging and discharging control signal, information indicating whether the storage battery 22 is being charged or power is being discharged from the storage battery 22. That is to say, the storage battery controller 32b is configured to serve as a discharge information acquirer, and to output discharge information indicating whether or not power is discharged from the storage battery 22. The distributed power supply system 1 is suitably configured such that if power is discharged from the storage battery 22 serving as an unauthorized non-utility power supply, reverse power flow from the distributed power supply system 1 to the utility power grid 5 is not observed. In this case, discharge information serves as a piece of information that allows the system to determine that reverse power flow is not currently observed (i.e., reverse power flow information). The storage battery controller 32b may also acquire the above discharge information by measuring the direction of charge or discharge current flowing between the storage battery 22 and the DC/DC converters 32 using, e.g., a sensor.

The system controller 34 may be implemented as a program installed in, e.g., a microcomputer, and may be configured to make bidirectional data communication with a remote controller 8 provided outside the power conditioner 3, the inverter controller 33b, and the storage battery controller 32b. The system controller 34 also acquires a current value detected by the CT sensor 7. The system controller 34 receives and uniformly manages various pieces of information including power factor setting information indicating, e.g., necessity or unnecessity of the power factor control and a designated value of the power factor which are set by the remote controller 8, a current value detected by the CT sensor 7 and/or discharge information of the storage battery 22 acquired by the storage battery controller 32b. Furthermore, the system controller 34 outputs, to the storage battery controller 32b, a storage battery control signal for controlling the charge/discharge of the storage battery 22.

The inverter 33 includes a bidirectional inverter circuit 33a and an inverter controller 33b. The respective output powers of the DC/DC conversion circuits 31a of the DC/DC converters 31 and the output power of the DC/DC conversion circuit 32a of the DC/DC converter 32 are added together, and the sum is input to the bidirectional inverter circuit 33a of the inverter 33. The output power of the inverter circuit 33a is supplied to the distribution switchboard 6.

The inverter controller 33b receives, e.g., the power factor setting information from the system controller 34, and reverse power flow information, such as an output power, from the converter controller 31b to control the output power and power factor of the inverter circuit 33a.

### Power Factor Control (1) of Distributed Power Supply System

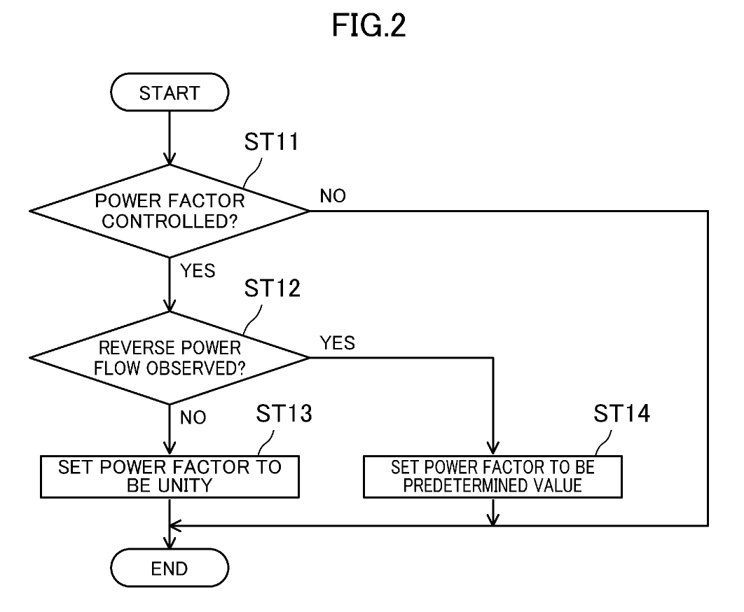

An exemplary operation of controlling the power factor in the distributed power supply system will now be described in detail with reference to FIG. 2. In the following description, the inverter controller 33b is supposed to be in charge of the overall control, unless otherwise stated.

First, in Step ST11, the inverter controller 33b determines, based on the power factor setting information provided by the system controller 34, whether or not the power factor needs to be controlled. If the power factor is not controlled (i.e., if the answer to the question of Step ST11 is NO), the power factor control process is ended without the power factor control. On the other hand, if the power factor is controlled (i.e., if the answer to the question of Step ST11 is YES), the inverter controller 33b receives information about the current direction (forward/backward) detected by the CT sensor 7 via the system controller 34 to determine whether or not reverse power flow is observed (in Step ST12). If the inverter controller 33b determines in Step ST12 that reverse power flow is observed (i.e., if the answer to the question of Step ST12 is YES), it performs a constant power factor control on the inverter circuit 33a such that the power factor is kept constant (i.e., power factor<unity) (in Step ST14).

In this processing step, if, e.g., the sum of the powers supplied from the distributed power supplies 2, 2, . . . , is larger than the power consumed by the load 9, the reverse power flow is observed. If the reverse power flow from the distributed power supply system 1 to the utility power grid 5 is observed, i.e., if the power is sold, electric utilities such as electric power companies may require the distributed power supply system 1 to be connected to the utility power grid 5 at a predetermined power factor in order to reduce an increase in the voltage of the utility power grid 5.

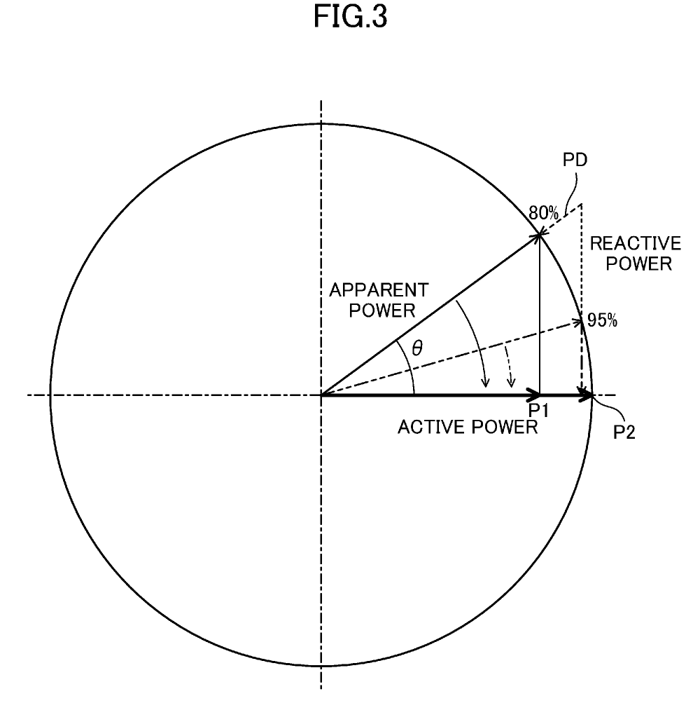

Thus, in the Step ST14, the inverter controller 33b controls the inverter circuit 33a so as to add reactive power to the power supplied from the distributed power supplies, and allows the inverter circuit 33a to output power with the power factor regulated to a predetermined constant value. FIG. 3 shows an example of output power when the predetermined constant power factor is 0.8. The power factor PF is calculated by the expression “PF=apparent power/active power (“cos θ” in FIG. 3).” Thus, in the example of FIG. 3, reactive power is added such that the PF has a value of 0.8.

The control of adding the reactive power is specifically implemented by allowing the inverter controller 33b to perform a leading or lagging power factor control. The leading power factor control refers to a power factor control for advancing a current phase relative to the voltage. The lagging power factor control refers to a power factor control for retarding a current phase relative to the voltage. It is possible to choose either the leading power factor control or the lagging power factor control upon, e.g., a request from the electric utilities. Any of these two power factor controls will achieve the same or similar advantage.

The inverter controller 33b controls the inverter circuit 33a during the reverse power flow such that the power factor of the inverter circuit 33a has a predetermined constant value (for example, 0.8). Such a power factor control may reduce a rise in the voltage of the utility power grid with more reliability.

Referring back to FIG. 2, if the inverter controller 33b determines that reverse power flow is not observed (i.e., if the answer to the question of Step ST12 is NO), it controls the inverter circuit 33a such that its power factor is unity (in Step ST13). Specifically, the reactive power is set to be “0” and only the active power is provided. This may increase the active power (see, e.g., P2 of FIG. 3) in a situation where the output current and output voltage of the distributed power supplies 2, 2, . . . , are equal to each other, compared with a case where the inverter 33 is controlled to have a predetermined constant power factor (see, e.g., P1 of FIG. 3).

In the present disclosure, controlling the circuit such that the power factor is unity includes controlling the circuit such that the power factor is substantially equal to unity. That is to say, this phrase also refers to a case where the power factor is controlled to be slightly smaller than unity due to, e.g., characteristics or control characteristics of the circuit, and the surrounding environment.

### Power Factor Control (2) of Distributed Power Supply System

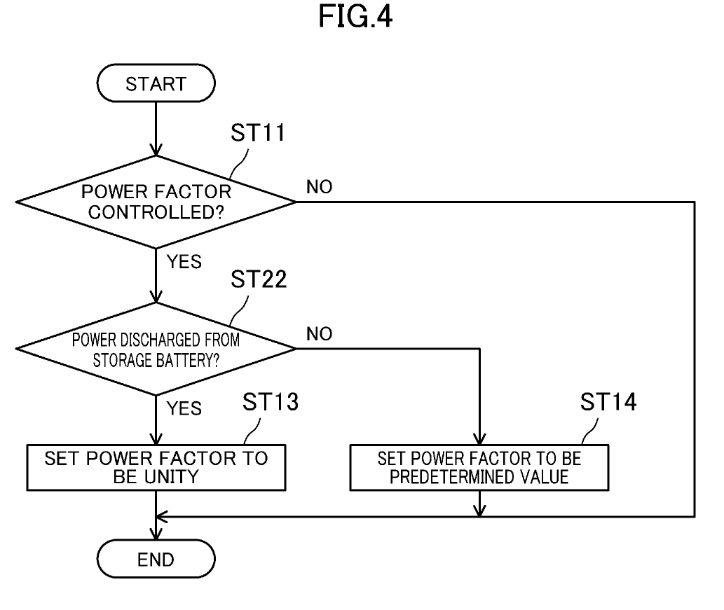

Another exemplary operation of controlling the power factor in the distributed power supply system will now be described in detail with reference to FIG. 4. In the following description, the inverter controller 33b is supposed to be in charge of the overall control, unless otherwise stated. The same reference characters will be used to denote the same or similar elements and processing steps as/to those used in the “Power Factor Control (1) of Distributed Power Supply System,” and the description thereof may be omitted herein.

First, in Step ST11, if the power factor is controlled (i.e., if the answer to the question of Step ST11 is YES), the inverter controller 33b confirms whether or not power is discharged from the storage battery 22 (in Step ST22). Specifically, the inverter controller 33b acquires discharge information of the storage battery 22 from the storage battery controller 32b via the system controller 34. In Step ST22, if the inverter controller 33b determines that power is discharged from the storage battery 22, it determines that reverse power flow is not observed since power is discharged from the unauthorized non-utility power supply from which reverse power flow is not allowed. Accordingly, the process proceeds to Step ST13, in which the inverter controller 33b controls the inverter circuit 33a such that the power factor is unity (in Step ST13). On the other hand, if no power is discharged from the storage battery 22 (i.e., if the answer to the question of Step ST22 is NO), the inverter controller 33b performs the constant power factor control such that the power factor is kept constant (power factor<unity) (in Step ST14). The control performed in Steps ST13 and ST14 is the same or similar as/to what has already been described for the “Power Factor Control (1) of Distributed Power Supply System,” and the detailed description thereof is omitted herein.

As can be seen, according to this embodiment, if the inverter controller 33b determines, based on the current direction detected by the CT sensor 7 as reverse power flow information and/or the discharge information of the storage battery 22, that reverse power flow is not observed, it controls the power factor such that the power factor is unity. This may improve the power efficiency of the distributed power supply system 1 in a situation where reverse power flow is not observed, i.e., power is supplied from the distributed power supplies 2, 2, . . . , to the load 9. If reverse power flow is not observed and power is discharged from the storage battery 22, the storage battery 22 is less exhausted compared with a case where the power factor of the power conditioner 3 (power converter device) is controlled to be kept constant.

### Other Embodiments

The exemplary embodiment of the present disclosure has been described. However, the embodiment may be readily changed or modified in various manners. The following are some of those numerous variations of the present disclosure.

For example, in Step ST13 in FIGS. 2 and 4, if the inverter controller 33b determines that reverse power flow is not observed, it controls the power factor of the inverter circuit 33a such that the power factor is unity. However, the power factor does not have to be controlled to be unity. For example, controlling the power factor of the inverter circuit 33a such that the power factor is closer to unity than the constant value of the power factor is may achieve an advantage of improving the power efficiency of the distributed power supply system 1. Still, it is nonetheless more advantageous to set the power factor of the inverter circuit 33a to be unity in order to improve the power efficiency more significantly.

In Step ST13 in FIGS. 2 and 4, if the inverter controller 33b determines that reverse power flow is not observed, it controls the power factor of the inverter circuit 33a such that the power factor is unity. In addition to this power factor control, the inverter controller 33b may also control the output power of the inverter circuit 33a such that the output power level of the inverter circuit 33a increases or decreases accordingly as the power consumed by the load 9 increases or decreases. Specifically, if, e.g., the power consumed by the load 9 decreases to the point that the output power of the inverter circuit 33a exceeds the power consumed by the load 9 while the power factor of the inverter circuit 33a is being controlled to be unity, the output power (active power) of the inverter circuit 33a is reduced. This allows no reverse power flow even if power is discharged from the storage battery 22, and thus, the power may be continuously discharged from the storage battery 22.

In Step ST14 in FIG. 2, the predetermined constant power factor is 0.8. However, the predetermined power factor may be set to be an arbitrary value. For example, the imaginary line in FIG. 3 indicates a situation where the power factor has a predetermined constant value of 0.95. Even in such a situation, if the inverter controller 33b has determined that reverse power flow is not observed, the inverter controller 33b controls the power factor such that the power factor is closer to unity than the constant power factor of 0.95 is. This may achieve the advantage of improving the power efficiency of the distributed power supply.

In the embodiment described above, the DC/DC converters 31 and 32 provided one to one for the respective photovoltaic power generators 21 and the storage battery 22 are supposed to be disposed in the power conditioner 3. However, this is only an exemplary embodiment of the present disclosure. For example, each of the DC/DC converters 31 may be built in an associated one of the photovoltaic power generators 21. Likewise, the DC/DC converter 32 may be provided on the storage battery 22 side.

In the embodiments described above, the authorized non-utility power supply is configured as the photovoltaic power generator 21. However, this is only an exemplary embodiment of the present disclosure. For example, instead of the photovoltaic power generators, any other power generators such as wind power generators or power storage devices may also be used. Alternatively, these different types of power generators and/or storage devices may also be used in combination. Even so, the same or similar advantage may be achieved.

Likewise, the unauthorized non-utility power supply is configured as the storage battery 22. However, this is only an exemplary embodiment of the present disclosure. For example, instead of the storage battery 22, any other power generator such as a cogeneration system and/or power storage device such as a fuel cell may also be used. Also, the storage battery 22 is not limited to a stationary storage battery. Alternatively, for example, a storage battery or fuel cell mounted on an electric vehicle may also be connected. Optionally, such batteries may also be used in combination, and the same or similar advantage may be achieved even in such a situation.

Furthermore, in the above embodiments, the storage battery 22 serves as the unauthorized non-utility power supply from which reverse power flow is not allowed. If reverse power flow is allowed from a power storage device (storage battery 22), however, the power storage device (storage battery 22) may also be regarded as an authorized non-utility power supply. The same statement may be applied to the power generator and/or power storage device, such as fuel cells, exemplified as another unauthorized non-utility power supply.

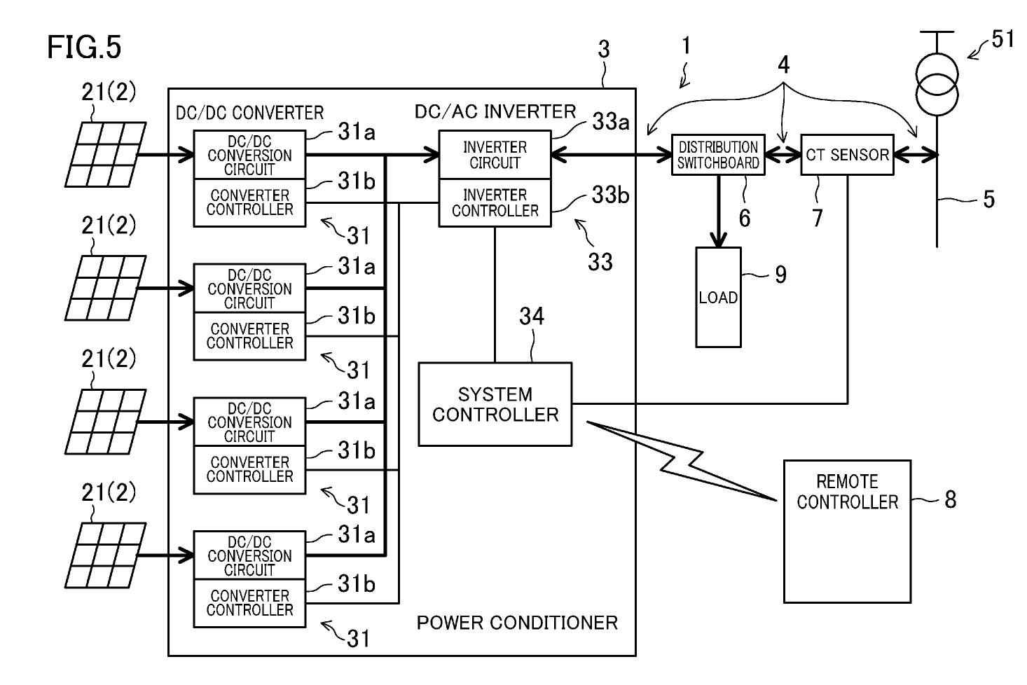

A specific example of the alternative configurations mentioned in the previous two paragraphs is shown in FIG. 5. As illustrated in FIG. 5, the storage battery 22 in FIG. 1 may be replaced with another photovoltaic power generator 21 that is another power generator and serves as another authorized non-utility power supply. The configuration shown in FIG. 5 may also achieve the same or similar advantage as/to that shown in FIG. 1.

The present disclosure may optimize the power efficiency while taking an appropriate countermeasure against a rise in grid voltage, and thus, is quite useful as a distributed power supply system in which a plurality of distributed power supplies are connected to a utility power grid.

What is claimed is:

1. A distributed power supply system comprising:
a plurality of distributed power supplies;
a power converter device having a DC/AC conversion function, and configured to DC/AC convert output power of the plurality of the distributed power supplies and supply the converted power to a load and to connect the plurality of the distributed power supplies to a utility power grid;
a reverse power flow information acquirer configured to acquire reverse power flow information indicating whether or not reverse power flow from the power converter device to the utility power grid is observed; and
a controller configured to control a power factor of the power converter device such that the power factor has a predetermined constant value if reverse power flow from the power converter device to the utility power grid is observed, wherein
if the controller determines, based on the reverse power flow information, that reverse power flow from the power converter device to the utility power grid is not observed, the controller controls the power factor of the power converter device such that the power factor has a value closer to unity than the predetermined constant value is.

2. The distributed power supply system of claim 1, wherein
the reverse power flow information acquirer is a current detector configured to detect a power transmission current flowing through a power transmission line connecting the power converter device to the utility power grid, and output the detected current as the reverse power flow information, and
if the controller determines, based on the power transmission current, that reverse power flow from the power converter device to the utility power grid is not observed, the controller controls the power factor of the power converter device such that the power factor has a value closer to unity than the predetermined constant value is.

3. The distributed power supply system of claim 1, wherein
the plurality of the distributed power supplies includes a power storage device,
the reverse power flow information acquirer is a discharge information acquirer configured to output, as the reverse power flow information, discharge information indicating whether or not power is discharged from the power storage device, and
if the controller determines, based on the discharging information, that power is discharged from the power storage device, the controller controls the power factor of the power converter device such that the power factor has a value closer to unity than the predetermined constant value is.

4. The distributed power supply system of claim 1, wherein
if the controller determines, based on the reverse power flow information, that reverse power flow from the power converter device to the utility power grid is not observed, the controller controls not only the power factor of the power converter device but also an output power level of the power converter device such that as the power consumed by the load increases or decreases, the output power level of the power converter device increases or decreases accordingly.

5. A method of controlling a power factor of a power converter device configured to DC/AC convert output power of a plurality of distributed power supplies and supply the converted power to a load and to connect the plurality of the distributed power supplies to a utility power grid, the power converter device being controlled such that the power factor has a predetermined constant value if reverse power flow from the power converter device to the utility power grid is observed, the method comprising:
acquiring reverse power flow information indicating whether or not reverse power flow from the power converter device to the utility power grid is observed; and
controlling the power factor of the power converter device such that the power factor has a value closer to unity than the predetermined constant value is, if a determination is made, based on the reverse power flow information, that reverse power flow from the power converter device to the utility power grid is not observed.

6. A power converter device comprising:
an inverter configured to DC/AC convert output power of a plurality of distributed power supplies and supply the converted power to a load and to connect the plurality of the distributed power supplies to a utility power grid;
a reverse power flow information acquirer configured to acquire reverse power flow information indicating whether or not reverse power flow from the inverter to the utility power grid is observed; and
a controller configured to control a power factor of the inverter such that the power factor has a predetermined constant value if reverse power flow from the inverter to the utility power grid is observed, wherein
if the controller determines, based on the reverse power flow information, that reverse power flow is not observed, the controller controls the power factor of the inverter such that the power factor has a value closer to unity than the predetermined constant value is.
